(19) United States
(12) Patent Application Publication
(10) Pub. No.: US 2026/0235302 A1
(43) Pub. Date: Aug. 13, 2026

(54) HEAT EMISSION CONTROL IN RADIATOR HEATER MATRIX

(71) Applicant: THE WARMING SURFACES COMPANY OY, Oulu (FI)

(72) Inventors: Terho KOLOLUOMA, Oulu (FI); Jarno VEHMAS, Rovaniemi (FI)

(21) Appl. No.: 19/470,847

(22) PCT Filed: Feb. 29, 2024
(86) PCT No.: PCT/FI2024/050077

§ 371 Date: Sep. 30, 2025

Related U.S. Application Data
(63) Continuation of application No. 18/194,826, filed on Apr. 3, 2023, now Pat. No. 12,566,002.

(30) Foreign Application Priority Data
May 2, 2023 (FI) 20235486

(51) Int. Cl. F24D 19/10; F24D 13/02

(52) U.S. Cl. CPC F24D 19/1096; F24D 13/024

(57) ABSTRACT

The present invention relates to a heater matrix and a method to manufacture a heater matrix comprising a plurality of heater pixels and electrical connections for the heater pixels. Each of said heater pixels comprises a resistive pattern attached on a face of a substrate or embedded in a substrate, wherein the resistive pattern is made of a layer of first conductive material and the resistive pattern has a first resistivity. Said electrical connections comprise electrical wiring attached on the face of the substrate or embedded in the substrate, wherein the electrical wiring is made of a layer of second conductive material and the electrical wiring has a second resistivity, the second resistivity being lower than the first resistivity.

### FIELD

The present invention relates to a radiator heating matrix. More particularly, the present invention relates to controlling emission in a radiator heater matrix.

### BACKGROUND

Recently, increasing energy prices have made people more cost conscious. It is well known that decreasing the indoor temperature reduces energy consumption. For example, energy costs decreased by 5% per centigrade indoor temperature decreased. Lower energy consumption reduces CO₂ emissions. Electricity is the most common type of green energy produced by utilizing renewable energy sources, such as solar, wind and low-impact hydro facilities, because green electricity is easy to produce and easy to deliver to consumers.

Keeping room temperature lower when the space is empty and increasing the temperature to a comfortable temperature when the space is occupied leads to energy savings. Comfort temperature varies from person to person. A too low or too high temperature in a room or other indoor space results discomfort and reduced working efficiency. Unfortunately, temperature control in existing indoor heating systems is too slow for altering the temperature profile of a space according to occupancy. Furthermore, in practice, temperature in buildings can be only controlled in a room level hence not allowing local differences within the space.

A heater matrix comprising a plurality of individually controllable heater pixels provides a solution that enables creating microclimates with temperatures within comfort temperature range within an indoor space in which the overall temperature maintained by a conventional heating system can be held below the comfort temperature range. For enabling quick response, heater pixels are preferably embedded close to the front face of various indoor building and/or decoration material sheets used on floors, walls, ceilings and even in furniture enabling rapid surface temperature change. Heater pixels of such heater matrix comprise resistive heater patterns which are heated electrically.

Operation reliability and safety are required from such heater matrix-based auxiliary heating system. Electrical current used for heating the heater pixels should be high enough to enable quickly heating the heater pixels, but on the other hand it is necessary to ensure that possibly high electric currents, although using low voltage, do not cause a risk of fire at any point of time. A major source of risk of malfunctions and hazards is electrical wiring that feeds the heater pixels and connections between different electrical elements of the heater matrix. A poor electrical connection between two electrical elements may cause generation of a hotspot that may cause a risk of equipment failure or even fire. Electrical wiring that feeds current to a plurality of heater pixels may carry higher current than any individual heater pixel.

### DESCRIPTION OF THE RELATED ART

In a commercially available heater-foil product, copper is used as a busbar in carbon paste-based heater foil. The copper busbar is glued to the carbon paste heater element using silver paste that forms electrical connection between copper and carbon. However, problems arise when a busbar and/or other wiring is coupled to a power source using glue or scrimp connectors, because these easily create hot spots: glue tends to become brittle over time and scrimp connector connections may degrade due to mechanical movement caused by temperature changes. Hot spots caused by poor connections may cause safety hazards. Furthermore, use of copper busbars is expensive and carbon paste is not practical to be used to create electrical wirings for power delivery because it has too low connectivity. Silver paste is expensive, and it has significant environmental impacts.

Soldering is a well-known method for electrically coupling traditional electronics. However, connecting bridges are typically made with insulation material and electrically conductive paste, such as silver paste glue. However, silver paste gluing is not reliable. Polyimide (PI) film based flexible circuit boards can even be coupled using traditional high-temperature soldering, but polyimide is expensive, and is thus not considered as a commercially preferable alternative if needed in large quantities.

So called crimp connection is a known alternative to solder connections: a crimp connector is crimped on a wire, and the crimp connector is further mechanically attached for example to the circuit board or to a film carrying a connector for example by pins or claws pushed through a wireline on the circuit board, or even attached by a screw or like. Such mechanical crimp connection is however unreliable, since it may disconnect, and/or various surfaces in the connection may oxidize resulting a hot spot.

US2021080121 A1 discloses a heating mat for surface heating of a room of a building. An electrical heating unit is arranged on a first base side of a carrier element so that the base unit can be laid flat over a surface heating system.

KR2020 0009660 A discloses a band heater system to be installed on an object such as a gas pipe. Connectors at both ends of the band portion enable connecting band portions to each other.

EP 3443810 B1 discloses a carbon nanomaterial-based electrically-powered heater element with electrodes and a carbon nanomaterial-containing layer placed on a substrate.

### SUMMARY

An object is to provide an apparatus so as to solve the problem of reliable electrical connection of heater pixels of a heater matrix with electrical power supply, while avoiding safety issues like hotspots in electrical contact areas and parasitic heating of wiring, as well as manufacturing methods to manufacture such apparatus. The objectives of the present invention are achieved with a heater matrix and with a heater matrix manufacturing process according to independent claims.

The preferred embodiments of the invention are disclosed in the dependent claims.

The present invention is based on the idea of selecting materials and/or designing patterns for the conducting heater pattern in the heater pixel on a substrate and for electrical wiring, in particular power feed lines on the substrate, such that resistivity of the conducting heater pattern is higher than that of the electrical wiring. Thus, the electrical current in the electrical wiring does not cause significant increase of temperature therein when turned on, but temperature of the heater pattern made of higher resistance material increases due to the current according to Ohm's law.

According to a first aspect, a heater matrix comprising a plurality of heater pixels and electrical connections for the heater pixels is provided. Each of said heater pixels comprises a resistive pattern attached on a face of a substrate or embedded in a substrate. The resistive pattern is made of a layer of first conductive material and the resistive pattern has a first resistivity. Said electrical connections comprise electrical wiring attached on the face of the substrate or embedded in the substrate. The electrical wiring is made of a layer of second conductive material and the electrical wiring has a second resistivity, the second resistivity being lower than the first resistivity.

According to some embodiments, said electrical connections further comprise a plurality of connecting bridges providing electrical connections between said heater pixels and said electrical wiring.

According to some embodiments, the plurality of connecting bridges is electrically connected to said heater pixels and to said electrical wiring by soldering.

According to some embodiments, solder paste used for soldering is a low temperature solder paste configured to perform self-healing of electrical connection over the solder paste in case of a hot spot being caused by a loose connection.

According to some embodiments, the plurality of connecting bridges is electrically connected to said heater pixels and to said electrical wiring by mechanical-electrical connectors, such as crimp connectors.

According to some embodiments, the plurality of connecting bridges is mechanically and electrically connected to said heater pixels and to said electrical wiring by anisotropic conductive film (ACF) or by anisotropic conductive paste (ACP).

According to some embodiments, the plurality of connecting bridges is mechanically and electrically connected to said heater pixels and to said electrical wiring by isotropic conductive film (ICF) or by isotropic conductive adhesive (ICA).

According to some embodiments, the plurality of connecting bridges is further fastened on the substrate by glue.

According to some embodiments, the first conductive material is brass, bronze, zinc, nickel, aluminium or copper and the second conductive material is copper.

According to some embodiments, both the layer of first conductive material and the layer of second conductive material have thickness from 0.5 to 50 micrometres, preferably from 10 to 30 micrometres, more preferably from 10 to 20 micrometres.

According to some embodiments, the electrical wiring comprises at least one power feed line, at least one ground feed line and the electrical wiring further provides data connection. The data connection is carried by the at least one power feed line or by one or more dedicated data communication lines.

According to some embodiments, the plurality of connecting bridges comprises at least one master connecting bridge and at least one slave connecting bridge. The at least one master connecting bridge is coupled to a power source for feeding the power feed lines, and to a controller configured to control operation of the heater matrix. The master connecting bridge comprises circuitry configured to control operation of the at least one slave connecting bridge based on control signals received from the controller.

According to some embodiments, the substrate is a sheet of building material or decoration material comprising one or more layers of fiber-based material, such as paper, cardboard, glass-fiber, carbon fiber, textile, fabric made of any such fiber-based material, polymer fiber, fiber reinforced material, laminate such as high-pressure laminate, glass fiber composite, polymeric material, polymeric film, inorganic material such as concrete, ceramic.

According to some embodiments, layer or layers of the substrate between the resistive pattern of the heater pixel and front face of the substrate is less than 3 mm, preferably less than 2 mm, most preferably less than 1 mm.

According to a second aspect, a method of manufacturing a heater matrix comprising a plurality of heater pixels and electrical connections for the heater pixels is provided. The method comprises patterning a layer of a first conductive material on a substrate or on a first sacrificial carrier to form a plurality of heater pixels. The patterned layer of first conductive material has a first resistivity. The method comprises patterning a layer of a second conductive material on the substrate or on the first or on a second sacrificial carrier to form electrical wiring. The patterned layer of second conductive material has a second resistivity lower than the first resistivity. If the first sacrificial carrier and/or first and second sacrificial carriers are used for patterning, the method comprises transferring the plurality of heater pixels and/or the electrical wiring from the respective sacrificial carrier to the substrate. The method further comprises attaching a plurality of connecting bridges on the substrate. Said attaching comprises electrically connecting the plurality of heater pixels to the electrical wiring via said connecting bridges.

According to some embodiments, the step of attaching the plurality of connecting bridges comprises applying soldering paste on predetermined locations of the heater pixels and the electrical wiring and/or on a plurality of connecting bridges, placing the plurality of connecting bridges on top of the heater pixels and electrical wiring, and soldering the heater matrix by temporarily heating the heater matrix for melting the soldering paste such that for electrically connecting heater pixels with electrical wiring via the connecting bridges.

According to some embodiments, said attaching a plurality of connecting bridges on the substrate comprises attaching the connecting bridges on the substrate by mechanical-electrical connectors such as crimp connectors for electrically connecting the heater pixels with the electrical wiring via the plurality of connecting bridges.

According to some embodiments, said attaching a plurality of connecting bridges on the substrate comprises attaching the connecting bridges on the substrate by means of anisotropic conductive film (ACF) or anisotropic conductive paste (ACP) for electrically connecting said heater pixels with the electrical wiring via the plurality of connecting bridges.

According to some embodiments, said attaching a plurality of connecting bridges on the substrate comprises attaching the connecting bridges on the substrate by means of isotropic conductive film (ICF) or isotropic conductive adhesive (ICA) for electrically connecting said heater pixels with the electrical wiring via the plurality of connecting bridges.

According to some embodiments, said attaching a plurality of connecting bridges on the substrate further comprises applying glue on the connecting bridges and/or on the substrate to fasten the connecting bridges on the substrate.

The present invention has the advantage that hotspots in contact areas are avoided, which would otherwise raise safety issues. The solution also avoids parasitic heating of electrical wiring especially when safe voltages and high currents are used to power one or more heater pixels of the heater matrix.

### BRIEF DESCRIPTION OF THE DRAWINGS

In the following the invention will be described in greater detail, in connection with preferred embodiments, with reference to the attached drawings, in which:

FIG. 1 illustrates a room comprising a heater matrix.

FIG. 2 illustrates a back face of an exemplary heater matrix carried by a substrate.

FIG. 3 is a schematic illustration of a cross-section of electrical connection between a heater pixel and power feed lines.

FIG. 4 illustrates a heater matrix according to some embodiments.

FIG. 5 illustrates a heater matrix according to some embodiments.

FIG. 6 illustrates a method of manufacturing a heater matrix.

FIG. 7 illustrates a method of manufacturing a heater matrix.

FIG. 8 illustrates a method of manufacturing a heater matrix.

FIG. 9 illustrates steps for attaching connecting bridges by soldering.

FIG. 10 illustrates steps for attaching connecting bridges by anisotropic conductive adhesive.

### DETAILED DESCRIPTION

In this context, front face refers to a face of a substrate that is intended to be facing towards inside of a room or other limited space. Back face refers to a face of the substrate that is intended to be facing away from the room or other limited space.

The heater matrix 100 comprises a plurality of resistive heater elements referred herein as heater pixels 10. Each heater pixel 10 represents a cell of the heater matrix 100. Heater pixels 10 can have any size and/or shape and they can be controlled individually or as groups.

Heater pixels 10 are carried by a substrate, either embedded within or provided on the face of the substrate. In this context, the substrate refers to any suitable interior building material or decoration material sheet. Heater pixels 10 may be embedded between selected layers of various materials forming the substrate. Heater pixels 10 may be embedded within a substrate material layer.

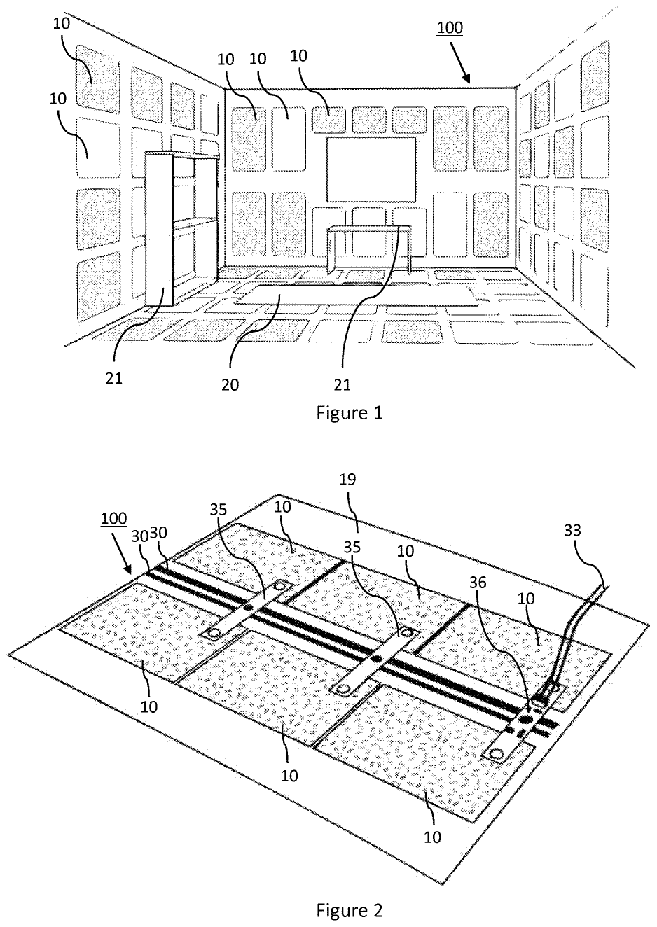

In the example shown in the FIG. 1, heater pixels 10 are provided at walls and at the floor, embedded in or provided on a face of various substrate materials installed on the wall and the floor, respectively. For example, heater pixels 10 at the walls may be carried by any fiber-based materials, such as paper, cardboard, glass-fiber, carbon fiber, textiles and fabrics made of them, polymer fibers and fiber reinforced materials made with the help of them. Such materials may include laminates such as high-pressure laminates, glass fiber composites etc. Heater pixels may be also integrated with polymeric materials and films as well as inorganic materials such as concrete and ceramics. Preferably, heater pixels are invisible in the room (space), in other words hidden behind at least one visible surface layer or layers of the respective substrates. In the FIG. 1, selective activation is illustrated by showing active heater pixels 10 with a pattern whereas inactive heater pixels 10 are white, outlined areas. In this context, selective activation means that any one or more individual heater pixel 10 or any one or more groups of heater pixels 10 can be activated separately from any other individual heater pixels 10 and/or groups of heater pixels. When activated, the heater pixel 10 generates a microclimate at vicinity thereof. By adjusting power fed to the one or more active heater pixels, temperature thereof and thus temperature of the generated microclimate is controlled.

Heater pixels 10 may be controlled individually or in groups. This enables controlling heater pixels 10 to be inactive when collocated with furniture 21 or a rug 20, as illustrated in the FIG. 1. On the other hand, one or more heater pixels located next to a piece of furniture 21 where a person often spends time, like an office desk, is preferably activated to create a comfortable, localized microclimate with a comfort temperature. Heater pixels 10 may also be embedded in furniture. For example, a sofa or a chair may comprise one or more heater pixels embedded in furniture upholstery fabric covering the sofa.

The FIG. 2 illustrates a simplified back face view of an exemplary heater matrix 100 carried by a substrate 19. This small exemplary heater matrix 100 may be implemented on a piece of any suitable building board or other building material, such as a laminate flooring, interior wall board, decoration material like wallpaper, wall panel or tiles, or fabric, such as upholstery fabric.

Each heater pixel 10 comprises a resistive heater element patterned out of conductive material, preferably metallic, such as Al, Ni, Cu, Fe, Zn or an alloy such as brass, bronze, German silver or their derivative such as phosphorous bronze, or carbon fiber. Conductive material may be applied in a printed form. In such a case, inks made of silver, carbon or copper or their mixtures may be used. According to a preferred embodiment, conductive material of the resistive heater element of the heater pixel is brass. As known in the art, the resistivity of brass is almost twice the resistivity of silver and copper. Aluminium, although otherwise suitable conductive material for this purpose, is somewhat problematic, because it is not compatible with common soldering materials and methods. The resistive heater element of the heater pixel is configured to be heated by controllably feeding electric current therein. If electrical coupling of the resistive heater element is not implemented by soldering, aluminium is a viable conductive material option.

As known in the art, electrical resistivity p can be calculated as

$$ρ = R ⋆ ( l / A )$$

wherein R is the electrical resistance of a uniform specimen of the material, l is the length of the specimen and A is the cross-sectional area of the specimen.

In an alternative embodiment, resistivities of the resistive heater elements and electrical wiring are designed adjusting cross-sectional area and/or length of respective patterns. In some embodiments, both the resistive heater element of the heater pixel and electrical wiring are both made of copper. Preferably, resistivity of the resistive heater element of the heater pixel is significantly higher than resistivity of the electrical wiring. For example, resistivity of the resistive heater element may be at least two or at least three times higher than resistivity of electrical wiring.

Furthermore, a combination of material selection and pattern design can be used for designing wanted, mutually different resistivities of resistive heater elements and electrical wiring.

The conductive material layer of the heater pixel 10 is thin. In this context, thin layer of conductive material refers to a layer of the order of 0.5 to 50 micrometers. In some embodiments, the thin layer of conductive material has a thickness from 10 to 30 micrometers. In some embodiments, the thin layer of conductive material has a thickness from 10 to 20 micrometers. The resistive heater element may be manufactured by printing, or by using converting technologies such as die cutting and lamination known in packaging industry or by using other roll-to-roll manufacturing technologies such as laser patterning, etching, and dry-etching, all of which enable generating a thin, patterned layer of the conductive material. A thin layer of conductive material facilitates invisibility of the heater pixels even if the substrate or layers of substrate in front side of the heater pixel, in other words between the heater pixel and front face of the substrate is/are also thin.

In the FIG. 2, electrical connections for the plurality of resistive heater elements of the heater pixels 10 are provided by connecting bridges 35, 36 electrically connected to electrical wiring 30. Electrical wiring 30 comprises power feed lines, which include at least one ground feed line and at least one operating voltage feed line. Further, electrical wiring 30 preferably provides means for data communications to facilitate individual controlling of each heater pixel 10. As is known in the art, data communications may be performed over various types of wireline communication. For example, electrical wiring 30 may be configured to provide data communications over dedicated data communication lines or buses, or data communication may be carried by power feed lines. Connecting bridges 35, 36 are provided with circuitry for controlling power delivery to the heater pixels 10, such as switching of power on or off, and/or controlling amount of power fed into the respective heater pixel 10. Electrical wiring 30 may comprise separate power and data lines, one or more buses carrying both power and data, or a combination of power feed lines and data bus. Electrical wiring 30 is further directly or indirectly coupled to a power source (not shown) and a controller. According to some embodiments, electrical wiring 30 is coupled to the power source and/or to the controller. According to some embodiments, at least one connecting bridge 36 is coupled to the power source and/or the controller by wires 33. Wires 33 may also carry data communication. According to some embodiments, data is communicated wirelessly between a wireless communication circuitry provided at a connecting bridge 36 and an external controller (not shown), for example a wireless remote controller or a wireless communication apparatus such as a mobile phone or a tablet computer provided with a remote-control application.

Like resistive patterns of the heater pixels 10, electrical wiring 30 is also made of conductive material, and according to some embodiments, electrical wiring may be printed, manufactured by using converting technologies known from printing and packaging industry such as die- or kiss cutting or laser patterning, or using traditional electronics manufacturing technologies, such as etching and dry-etching, or they may be laminated. Conductive material of the electrical wiring 30 may be metallic, such as Al, Ni, Cu, Fe, Zn or an alloy such as brass, bronze, German silver or their derivative such as phosphorous bronze etc.

Conductive material may also be applied in a printed form. In such a case, inks made of silver, carbon or copper or their mixtures may be used. According to embodiments of the invention, conductive material used in electrical wiring 30 is selected such that conductivity of electrical wiring 30 is better than conductivity of resistive heater elements of heater pixels 10 so that electrical wiring 30 does not significantly heat when heater pixels 10 are active.

Like the heater pixel 10, also conductive material layer of the electrical wiring 30 is thin. In this context, thin layer of conductive material refers to a layer of the order of 0.5 to 50 micrometers. In some embodiments, the thin layer of conductive material has a thickness from 10 to 30 micrometers. In some embodiments, the thin layer of conductive material has a thickness from 10 to 20 micrometers. A thin layer of conductive material facilitates invisibility of the electrical wiring even if the substrate or layers of substrate in front side of the electrical wiring, in other words between the electrical wiring and front face of the substrate is/are also thin. In this context, a substrate or layers of substrate is/are considered thin, when total thickness of substrate is not more than 3 mm, preferably not more than 2 mm, most preferably not more than 1 mm. Preferably, electrical wiring 30 is applied on the same layer of the substrate 19 or between the same layers of the substrate 19 as the heater pixels 10. However, this is not necessary, since electrical wiring 30 is not intended to produce a heating effect towards the space heated by the heater matrix.

According to some embodiments, the resistance of an individual heater pixel 10 is between 12 and 48Ω, preferably 24Ω and operating voltage is within range from 12 to 48 V, depending on desired heating power and the resistance. According to some embodiments, there are two types of connecting bridges 35, 36. First connecting bridge 36 is coupled to wiring 33 and may comprise circuitry to control operation of a plurality of second connecting bridges 35, which only comprise circuitry to control operation of the respective heater pixels 10 it is directly coupled to. Thus, the first connecting bridge 36 may be referred to as a master connecting bridge, while the second connecting bridges 35 may be referred to as slave connecting bridges.

A roll-to-roll manufacturing method can be applied to facilitate mass production of the plurality of heater pixels 10 and electrical wiring 30 on the substrate 19. An exemplary method for manufacturing patterned resistive heater elements useable in heat pixels 10 is disclosed in international patent application WO 2022/234189. A plurality of heater pixels 10 is electrically connected to form the heater matrix 100. Electrical wiring 30 for heater pixels 10, may be generated at least partially during the manufacturing process of heater pixels 10, but electrical wiring may also be generated after the manufacturing process of heater pixels 10.

Heater pixels 10 may be integrated to various interior building or decoration material sheets useable as a substrate 19 of the heater matrix 100. For example, heater pixels 10 may be integrated to fabrics, such as furniture upholstery fabric, curtains, blinds, decoration fabrics and textiles, as well as laminates, such as flooring laminates, wall boards and fiber enforced composites such as glass fiber. Preferably, the conductive material pattern is disposed in proximity of the outer face of the substrate 19 such that there is only a thin layer or layers of substrate materials between the conductive material pattern of the heater pixel 10 and the front face of the substrate 19. With the front face of the substrate, we refer to the surface that is intended to be directed towards inhabitants of a room or other space, whereas the back face refers to the face that is away from the room or space. A thin layer or layers of material reduces power loss in material layers between the heater pixel and the space it is intended to warm up and enables fast temperature to increase at the front face surface of the substrate.

When the substrate 19 is thin enough not to cause significant heat loss when passing through the sheet of substrate material, heater pixels 10 and electrical wiring 30 can be patterned on the back face of the substrate 19. This is beneficial since electrical connections are easier and thus cheaper to manufacture when heater pixels 10 and electrical wiring 30 are visible on the back face of the substrate 19.

Heater pixels may even be patterned on the front face of the substrate, but it is typically preferred that front face of the material sheet does not have visible heater pixels or other electrical elements, which would thus be visible in the interior of the space. On the other hand, heater pixels patterned on a front face of some indoor building material could be hidden behind any standard tapestry or like, in which case heater pixels may reside on the front face of the substrate, because they will be eventually hidden by the tapestry. Care should be taken, however, that material used for tapestry or other covering material as well as material used to fix the tapestry on top of such exposed heater matrix is compatible and safe to use with the heater matrix. Even if heater pixels were patterned on the front face of the substrate, connecting bridges should not be placed on the front face of the substrate, because they would protrude from the essentially flat front face. Rather, connecting bridges should be arranged on the back face or embedded in or between intermediate layers of the substrate.

Although a variety of substrate materials may be used for the heater matrix, selection of applicable substrate materials should be made with considerations of safety. The plausible temperature range at any position of the heater matrix while in use should be clearly below temperature that would cause a risk of fire by used substrate material or materials. Any fireproof substrate material may be used and/or one or more substrate materials may be handled with a flame retardant.

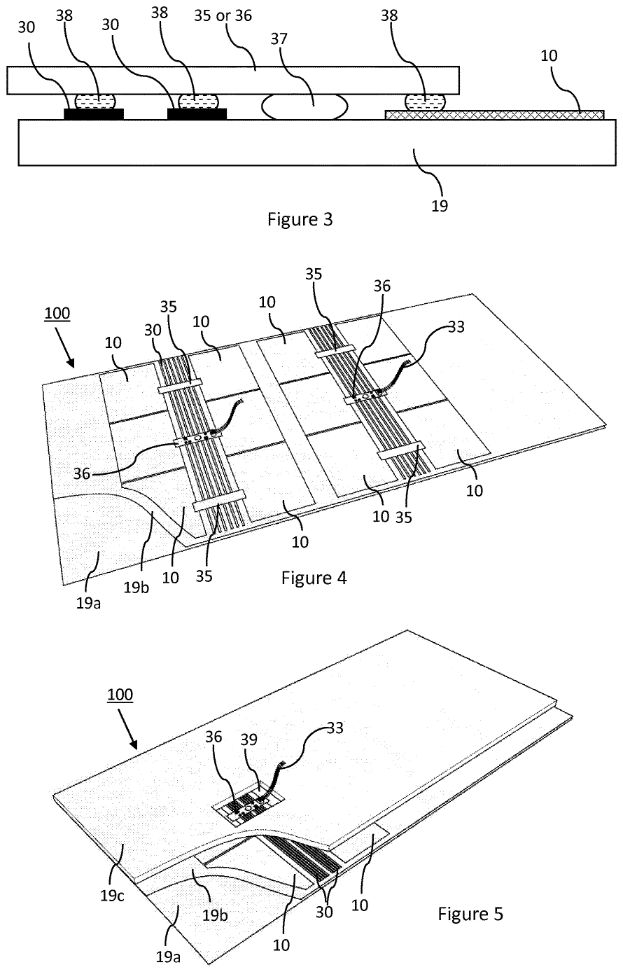

FIG. 3 illustrates schematically a cross-section of electrical connection between a heater pixel and electrical wiring according to some embodiments. The drawing is not in scale.

The resistive pattern of the heater pixel 10 as well as electrical wiring 30 are on back face of a thin substrate 19 or on back side of one or more surface layers of the substrate 19, such as surface layers of a laminate used for flooring. In this context surface layers refer to layers such as a wear layer, a decorative layer and/or a thin support layer, wherein total thickness of the substrate 19 on front side of the heater pixels 10 is preferably not more than 2 or 3 mm. Any thicker core layers of the substrate should be placed on the back side of heater pixels 10 as will be described in connection to FIG. 4. Although not shown in the FIG. 3, the substrate 19 may comprise a plurality of material layers. In this embodiment, printed circuit boards (PCBs) are used as connecting bridges 35, 36 between the heater pixels 10 and electrical wiring 30. As known by those skilled in the art, a PCB comprises electrical connections between connection pads for attaching electrical and electronic components and/or other elements of an electrical circuitry thereon.

The connecting bridge 35, 36 may be of any known type of PCB, including, but not limited to various known FR-type and CEM-type dielectric-based PCBs, ceramic PCBs as well as any known type of flexible PCBs. Traditional PCBs are typically cost effective but should preferably be used only with rigid carriers to avoid disengaging of electrical connections due to bending of the substrate, while flexible PCBs are more expensive, but enable use of more flexible substrates. Preferably, the type of connecting bridges 35, 36 is selected such that they are easily and reliably electrically connectable to both the heater pixel 10 and the electrical wiring 30. The connecting bridges 35, 36 may be embedded to a material layer of the substrate: for example, oriented strand (OSB) board, a high-density fiberboard (HDF) or medium density fiberboard (MDF) may be provided with recesses or grooves for connecting bridges 35, 36 such that heater pixels 10 are provided on the front face of the board acting as a core layer. On the other hand, the connecting bridges may reside on the back face of the substrate, when the substrate is thin enough not to cause significant thermal losses. When the substrate 19 is flexible also the connecting bridges 35, 36 are preferably flexible so that bending of the substate 19 does not cause disengaging solder connections between the connecting bridge 35, 36 and the heater pixel 10.

Solder 38 is preferably used for electrically and mechanically connecting the connecting bridge 35, 36 to the resistive pattern of the heater pixel 10 and to electrical wiring 30 provided on the substrate 19. In some embodiments, a low temperature solder paste is preferred to avoid exposing the substrate to excess heat during soldering. Known examples of such low temperature solder pastes are tin and bismuth-based alloys.

Another possible connection method is to use anisotropic conductive film (ACF), or isotropic conductive film (ICF) which are lead-free and environmentally friendly adhesive interconnect systems, anisotropic conductive paste (ACP) or isotropic conductive adhesive (ICA). ACF and ACP are collectively referred to as anisotropic conductive adhesive (ACA). ACA, ICF or ICA may be used to couple the connecting bridge 35, 36 to the substrate and its electrical wiring 30. Compared to soldering, ACA, ICF and ICA typically require a larger lateral connection area to safely carry required electrical currents, which may exceed 20 A, to feed power to the heater matrix. The ACA, ICF or ICA may require further mechanical support to ensure a reliable mechanical and electrical connection.

Connecting bridges 35, 36 may further be attached to the substrate 19 by glue 37 to further enhance mechanical connection between the two. Glue 37 is preferably applied prior to soldering, so that it serves the purpose of keeping the connecting bridge 35, 36 in place during soldering.

FIG. 4 illustrates a heater matrix 100 according to some embodiments. For example, the substrate 19 in the FIG. 4 is a laminate or the substrate 19 is shown in the FIG. 4 comprises two top layers of a laminate, forming the visible front face thereof. The top layers may be further attached to a core layer.

Resistive patterns of heater pixels 10 of the heater matrix 100 as well as electrical wiring 30 are attached on a back face of these top layers of the relatively thin substrate 19. In this example, the substrate 19 comprises two layers. Front face of the substrate 19 is a decorative layer 19a, also referred to as a print layer or a pattern layer, which determines the visual appearance of the substrate. The decorative layer 19a may also comprise fabric.

In this example, there is a supporting layer 19b on the back of the decorative layer 19a. Type and material of the supporting layer 19b is selected based on intended use of the substrate 19. For example, the supporting layer 19b may comprise one or more layers of paper. According to some embodiments these layers of paper in the supporting layer 19b are impregnated with liquid melamine.

Depending on intended use of the substrate 19, front face of the decorative layer 19a may further be covered by an additional top layer, typically referred to as a wear layer, which protects the decorative layer 19a from wear.

All layers on front side of the resistive patterns of the heater pixels 10 are preferably thin. For example, in laminate flooring, thickness of a wear layer is typically less than 1 mm, preferably less than 0.5 mm. Thickness of the decorative layer 19a is less than 0.5 mm. Additional supporting layer 19b may be slightly thicker but is also typically in range of 1 to 2 mm. Thus, resistive patterns of the heater pixels 10 are disposed close to the front face of the substrate, i.e. preferably less than 1 or 2 or 3 mm from the front face. The less the total thickness of substrate layers in front side of the heater pixels 10, the faster the front face of the substrate warms up when one or more heater pixels 10 are switched on. The front face refers to the face of the substrate that is intended to be installed towards the space to be heated by the heater matrix 100. Portion of the supporting layer 19b and one of the heater pixels 10 have been cut off in the FIG. 4 for visualization. Shapes and sizes of heater pixels 10 can vary, although controlling operation thereof is easier if they are approximately of the same size and/or have mutually at least approximately similar resistance. Electrical wiring 30 is attached on the substrate between heater pixels 10. Connecting bridges 35, 36 provide individually controllable electrical connections between electrical wiring 30 and heater pixels 10 for controlling operation of the heater pixels 10. Connecting bridges 35, 36 comprise electronics for controlling operation of heater pixels 10.

A laminate flooring may lack the supporting layer 19b, if the decorative layer 19a, and the protective layer are intended to be attached on a thicker core layer.

FIG. 5 illustrates a heater matrix 100 according to some embodiments. In addition to the decorative layer 19a and the supporting layer 19b, the substrate further comprises a core layer 19c, sometimes referred as a substrate layer. The core layer 19c is selected according to intended use of the substrate. The core layer 19c may be, for example, oriented strand (OSB) board, fiberboard, medium-density fiberboard (MDF) or high-density fiberboard (HDF).

According to some embodiments, the layered structure shown in the FIG. 4 is further attached to the core layer 19c, such that the back side of the front facing thin layers of the substrate, in other words the side with the resistive patterns of heater pixels 10, electrical wiring 30 and connecting bridges 35, 36 are towards the thicker and more mechanically stable core layer 19c. In the FIG. 5, portions of the support layer 19b, the core layer 19c and one of the heater pixels 10 have been removed for visualization. The core layer 19c adds mechanical support to the substrate 19, while the heater pixels 10 remain separated from the front face of the structure only by thin layers, such as the optional support layer 19b and the decorative layer 19a, as well as an optional wear layer. According to some embodiments, only a decorative layer 19a and a wear layer are provided on the front side of the heater pixels 10, and desired mechanical support is provided at the back side of the heater pixels 10 by the core layer 19c.

In this example, a master connecting bridge 36 coupled to wiring 33 is exposed at the back side of the core layer 19c by an opening 39 created by removing a portion of the core layer 19c collocated with the respective master connecting bridge 36. Other, slave connecting bridges 35 (not shown) are preferably disposed in a plurality of respective recesses provided on the front side of the core layer 19c, collocated with the slave connecting bridges 35, which are thus hidden from sight between the rather thick core layer 19c and front facing layers 19a, 19b of the substrate. The core layer 19c may be several millimeters thick. For example, a typical laminate flooring has a total thickness of 6 to 12 mm, and thickness of the core layer is about 5 to 11 mm. The laminate may comprise further layers, such as a backing layer (not shown) on the back face of the core layer 19c. In such case, the backing layer preferably has like openings as the core layer 19c to expose the master connecting bridge 36 for electrical connections.

In this example, the master connecting bridge 36 is coupled by wires 33 to a power source for feeding the power feed lines. The master connecting bridge 36 is also communicatively coupled to a controller configured to control operation of the heater matrix. The master connecting bridge comprises circuitry configured to control operation of the at least one slave connecting bridge based on control signals received from the controller. Wires 33 may be at least partially replaced by the electrical wiring 30 on the back face or embedded in the substrate 19.

Typical materials used in the core layers 19c of laminates and other building boards are thermally insulating and therefore resistive patterns of heater pixels should not be placed on back side (behind) any such layer to avoid reduction of achievable heating effect by the heater pixels 10. By placing resistive pattern of heater pixels 10 in front of the core layer 19c, thickness of layers between the front surface of the substrate and the heater pixels 10 can be minimized, while heater pixels and electrical wiring remain hidden from sight and kept away from being touchable by inhabitants.

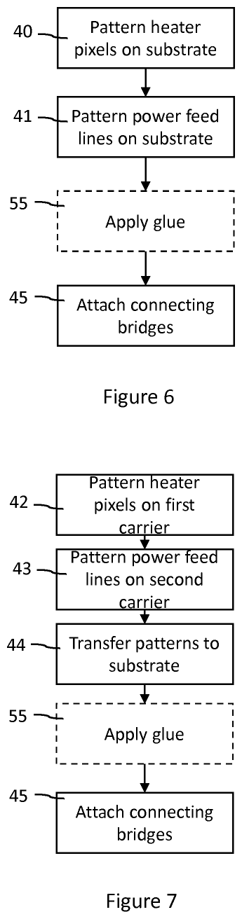

FIG. 6 illustrates a method of manufacturing a heater matrix according to some embodiments.

In the step 40, a thin layer of a first conductive material with a first resistivity is patterned on a face of a substrate to form a plurality of resistive patterns of a plurality of heater pixels. The first conductive material has a first resistivity. According to some embodiments, the first conductive material may be brass, which is a copper and zinc alloy.

In the step 41, a thin layer of a second conductive material is patterned on the face of the substrate to form power feed lines. The second conductive material has a second resistivity that is lower than the first resistivity. According to some embodiments, the second conductive material is copper.

Steps 40 and 41 may be performed in any order: they may be performed simultaneously or either one may be performed first.

In the optional step 55, glue is applied on the connecting bridges and/or on the substrate to facilitate good mechanical connection between the connecting bridge and the substrate.

In the step 45, connecting bridges are attached to the substrate such that a mechanical connection and desired electrical connections are created.

FIG. 7 illustrates a method of manufacturing a heater matrix according to some embodiments.

In the step 42, a thin layer of a first conductive material with a first resistivity is patterned on a face of a sacrificial carrier to form a plurality of heater pixels. The first conductive material has a first resistivity. According to some embodiments, the first conductive material may be brass, which is a copper and zinc alloy.

In the step 43, a thin layer of a second conductive material is patterned on the face of a second sacrificial carrier to form power feed lines. The second conductive material has a second resistivity that is lower than the first resistivity. According to some embodiments, the second conductive material is copper.

Steps 42 and 43 may be performed in any order: they may be performed simultaneously or either one may be performed first.

In the step 44, heater pixel patterns are transferred from the first sacrificial carrier to the face of a substrate and power feed line patterns are transferred from the second sacrificial carrier to the face of the substrate.

In the step 45, connecting bridges are attached to the substrate such that a mechanical connection and desired electrical connections are created.

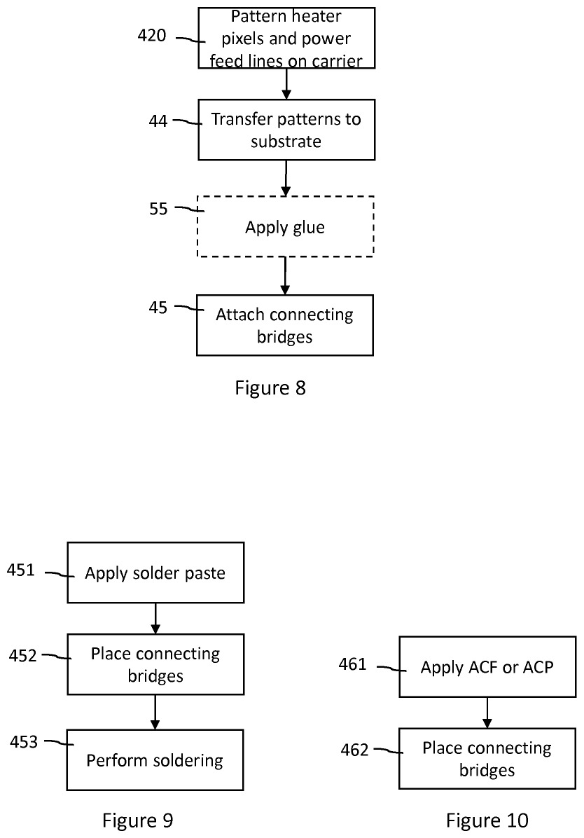

FIG. 8 illustrates a method of manufacturing a heater matrix according to some embodiments.

In the step 420, a thin layer of a first conductive material with a first resistivity is patterned on a face of a sacrificial carrier to form a plurality of heater pixels and a thin layer of a second conductive material is patterned on the face of the sacrificial carrier to form power feed lines. The first conductive material has a first resistivity. According to some embodiments, the first conductive material may be brass, which is a copper and zinc alloy. The second conductive material has a second resistivity that is lower than the first resistivity. According to some embodiments, the second conductive material is copper.

Patterning the heater pixels and the power feed lines on the sacrificial carrier may be performed simultaneously or either one may be performed first.

Steps 44 to 45 are performed as already described above.

Several alternatives can be used for attaching connecting bridges, step 45.

FIG. 9 illustrates steps for attaching connecting bridges by soldering, according to some embodiments.

In the step 451, solder paste is applied on predetermined locations of the heater pixels and electrical wiring and/or on connection pads of a plurality of connecting bridges, such as printed circuit boards (PCB) which comprise defined electrical connections between a plurality of connection pads provided on a face of the connecting bridge.

Solder paste may be selected among any known types of solder paste. According to some embodiments, a low temperature solder paste is used, which is suitable for self-healing: if a hot-spot would be caused in the heater matrix due to a poor electrical connection, heat of such hot-spot would re-melt the solder so that proper electrical connection is re-established.

In the step 452, the plurality of connecting bridges is placed on the heater pixels and electrical wiring such that areas provided solder paste become collocated with desired contact points on the respective connecting bridge and on electrical wiring and the heater pixel.

In the step 453, soldering is performed using any known soldering method. As known in the art, soldering comprises temporarily heating at least the soldering paste for melting it such that electrical connections are formed between the heater pixels, electrical wiring, and the connecting bridges. When the solder paste is cured, it also forms a mechanical connection between these elements. The maximum temperature allowed in the soldering phase shall be within allowable limits of all materials of the structure, including the substrate, which likely has the lowest allowed temperature range. If glue was applied in the step 55, glue further facilitates good mechanical connection between the connecting bridge and the substrate.

FIG. 10 illustrates steps for attaching connecting bridges by means of ACF or ACP, according to some embodiments.

In the step 451, ACF or ACP is applied on predetermined locations of the heater pixels and electrical wiring and/or on connection pads of a plurality of connecting bridges.

In the step 452, the plurality of connecting bridges is placed on the heater pixels and electrical wiring such that areas provided ACF or ACP become collocated with desired contact points on the respective connecting bridge thus create desired electrical connections.

According to some embodiments, no soldering is used, but desired electrical connections between connecting bridges, heater pixels and power feed lines are provided by mechanical-electrical connectors, such as crimp connectors. For example, suitable wiring is provided with crimp connectors at its ends, which are attached on desired coupling pads provided on the substrate mechanically, for example by metal spikes or screws attaching the crimp connector on the substrate.

A combination of brass as the first conductive material and copper as the second conductive material is preferred in any of the above-described embodiments. As known, conductivity of brass is just 28% of conductivity of copper. Thus, current that is sufficient for warming up the resistive pattern while the power feed lines feeding power to resistive patterns are not significantly heated. If an even greater difference in conductivity is needed bronze may be used as the first conductive material together with copper as the second conductive material. Further alternative conductive material combinations having suitable mutual difference in conductivity for such purpose are zinc and copper, nickel and copper and aluminium and copper.

It is apparent to a person skilled in the art that as technology advanced, the basic idea of the invention can be implemented in various ways. The invention and its embodiments are therefore not restricted to the above examples, but they may vary within the scope of the claims.

1. A heater matrix comprising a plurality of heater pixels and electrical connections for the heater pixels,
wherein each of said heater pixels is a resistive pattern attached on a face of a substrate or embedded in a substrate, wherein the resistive pattern is made of a layer of first conductive material and the resistive pattern has a first resistivity,
and said electrical connections comprise electrical wiring attached on the face of the substrate or embedded in the substrate, wherein the electrical wiring is made of a layer of second conductive material and the electrical wiring has a second resistivity, the second resistivity being lower than the first resistivity,
characterized in that said electrical connections comprise a plurality of connecting bridges, each connecting bridge providing an electrical connection between at least one heater pixel and the electrical wiring, and each connecting bridge being electrically connected to said at least one heater pixel and to the electrical wiring by soldering, mechanical electrical connectors, anisotropic conductive film (ACF), anisotropic conductive paste (ACP), isotropic conductive film (ICF) and isotropic conductive adhesive (ICA).

2. The heater matrix according to claim 1, wherein solder paste used for soldering is a low temperature solder paste configured to perform self-healing of electrical connection over the solder paste in case of a hot spot being caused by a loose connection.

3. The heater matrix according to any claim 1 or 2, wherein the plurality of connecting bridges is further fastened on the substrate by glue.

4. The heater matrix according to any one of claims 1 to 3, wherein the first conductive material is brass, bronze, zinc, nickel or aluminium and the second conductive material is copper.

5. The heater matrix according to any one of claims 1 to 4, wherein both the layer of first conductive material and the layer of second conductive material have thickness from 0.5 to 50 micrometers, preferably from 10 to 30 micrometers, more preferably from 10 to 20 micrometers.

6. The heater matrix according to any one of claims 1 to 5, wherein the electrical wiring comprises at least one power feed line, at least one ground feed line and the electrical wiring further provides data connection, wherein the data connection is carried by the at least one power feed line or by one or more dedicated data communication lines.

7. The heater matrix according to any one of claims 1 to 6, wherein the plurality of connecting bridges comprises at least one master connecting bridge and at least one slave connecting bridge, wherein the at least one master connecting bridge is coupled to a power source for feeding the power feed lines, and to a controller configured to control operation of the heater matrix, and wherein the master connecting bridge comprises circuitry configured to control operation of the at least one slave connecting bridge based on control signals received from the controller.

8. The heater matrix according to any one of claims 1 to 7, wherein the substrate is a sheet of building material or decoration material comprising one or more layers of fiber-based material, such as paper, cardboard, glass-fiber, carbon fiber, textile, fabric made of any such fiber-based material, polymer fiber, fiber reinforced material, laminate such as high-pressure laminate, glass fiber composite, polymeric material, polymeric film, inorganic material such as concrete, ceramic.

9. The heater matrix according to any one of claims 1 to 8, wherein thickness of layer or layers of the substrate between the resistive pattern of the heater pixel and front face of the substrate is less than 3 mm, preferably less than 2 mm, most preferably less than 1 mm.

10. A method of manufacturing a heater matrix comprising a plurality of heater pixels and electrical connections for the heater pixels, the method comprising:
patterning a layer of a first conductive material on a substrate or on a first sacrificial carrier to form a plurality of heater pixels, the patterned layer of first conductive material having a first resistivity;
patterning a layer of a second conductive material on the substrate or on the first or on a second sacrificial carrier to form electrical wiring, the patterned layer of second conductive material having a second resistivity, the second resistivity being lower than the first resistivity;
if the first sacrificial carrier and/or first and second sacrificial carriers are used for patterning, transferring the plurality of heater pixels and/or the electrical wiring from the respective sacrificial carrier to the substrate;
characterized in that the method comprises:
attaching a plurality of connecting bridges on the substrate, wherein said attaching comprises electrically connecting the plurality of heater pixels to the electrical wiring via said connecting bridges, and wherein said attaching comprises electrically connecting said connecting bridges to at least one heater pixel and to the electrical wiring by any one of soldering, mechanical-electrical connectors, anisotropic conductive film (ACF), anisotropic conductive paste (ACP), isotropic conductive film (ICF) and isotropic conductive adhesive (ICA).

11. The method according to claim 10, wherein the step of attaching the plurality of connecting bridges comprises:
applying soldering paste on predetermined locations of the heater pixels and the electrical wiring and/or on a plurality of connecting bridges;
placing the plurality of connecting bridges on top of the heater pixels and electrical wiring;
soldering the heater matrix by temporarily heating the heater matrix for melting the soldering paste such that for electrically connecting heater pixels with electrical wiring via the connecting bridges.

12. The manufacturing method according to claim 10 or 11, wherein the attaching a plurality of connecting bridges on the substrate further comprises:
applying glue on the connecting bridges and/or on the substrate to fasten the connecting bridges on the substrate.
